(19) United States
(12) Patent Application Publication
(10) Pub. No.: US 2007/0089432 A1
(43) Pub. Date: Apr. 26, 2007

(54) Cryostat configuration with cryocooler

(75) Inventors: Johannes Boesel, Neuheim (CH); Urs Meier, Wetzikon (CH); Andreas Kraus, Riedikon (CH); Beat Mraz, Bubikon (CH)

Correspondence Address: KOHLER SCHMID MOEBUS, RUPPMANNSTRASSE 27, D-70565 STUTTGART, DE

(73) Assignee: Bruker BioSpin AG, Faellanden (CH)

(21) Appl. No.: 11/443,268

(22) Filed: May 31, 2006

(30) Foreign Application Priority Data
Jun. 23, 2005 (DE) 10 2005 029 151.1

(51) Int. Cl. F25B 9/00; F17C 5/02; F25B 19/00

(52) U.S. Cl. 62/51.1; 62/6; 62/47.1

(57) ABSTRACT

A cryostat configuration for keeping cryogenic fluids in at least one cryocontainer, comprising an outer shell and a neck tube containing a cold head of a cryocooler, wherein the coldest cold stage of the cold head is disposed in a contact-free manner relative to the neck tube and the cryocontainer, and wherein a cryogenic fluid is located in the neck tube, is characterized in that the neck tube is disposed between the outer shell and a cryocontainer and/or the radiation shield, the neck tube is closed in a gas-tight manner at the end facing the cryocontainer and/or the radiation shield, the neck tube is coupled to the cryocontainer and/or a radiation shield disposed between the cryocontainers or a cryocontainer and the outer shell, via a connection having a good thermal conductivity, the neck tube comprising a fill-in device at an end located at ambient temperature. This permits efficient heat transfer between the cryocooler and the cryocontainer with little vibration, while simultaneously ensuring great safety during maintenance work without discharging the magnet.

This application claims Paris Convention priority of DE 10 2005 029 151.1 filed Jun. 23, 2005 the complete disclosure of which is hereby incorporated by reference.

### BACKGROUND OF THE INVENTION

The invention concerns a cryostat configuration for keeping cryogenic fluids in at least one cryocontainer, comprising an outer shell and a neck tube in which a cold head of a cryocooler is installed, wherein at least the coldest cooling stage of the cold head of the cryocooler is disposed in such a manner that it does not contact the neck tube and the cryocontainer, wherein a cryogenic fluid is contained in the neck tube.

A cryostat configuration of this type is disclosed in US 2002/0002830 A1.

In cryostat configurations for keeping liquid cryogens, which are used e.g. in nuclear magnetic resonance (NMR) measuring apparatus, a superconducting magnet coil system is disposed in a first container containing liquid cryogen, usually liquid helium, which is surrounded by radiation shields, super insulation foils and optionally a further container with a cryogenic liquid, usually liquid nitrogen. The liquid containers, radiation shields and super insulation foils are accommodated in an outer container that delimits a vacuum chamber (outer shell, outer vacuum cover). The superconducting magnet is kept at a constant temperature by the surrounding evaporating helium. The elements surrounding the first cryocontainer thermally insulate the container to minimize the heat input into the container as well as the helium evaporation rate. Magnet systems for high-resolution NMR spectroscopy are usually so-called vertical systems, wherein the coil configuration axis and the opening for receiving the NMR sample extend in a vertical direction. The helium container of NMR spectrometers is usually connected to the outer vacuum cover via at least two thin-walled suspension tubes. The container is thereby mechanically fixed and the suspension tubes provide access to the magnet as is required e.g. for cooling and charging. Moreover, the waste gas is discharged via the suspension tubes, thereby cooling the suspension tubes and, in the ideal case, completely compensating for the heat input via the tube wall. A system of this type is described e.g. in DE 29 06 060 A1 and in the document “Superconducting NMR Magnet Design” (Concepts in Magnetic Resonance, 1993, 6, 255-273).

However, handling of the cryogens is difficult. They must be refilled at certain time intervals which often requires undesired interruption of the measurements. The dependence on liquid cryogens is also problematic if the infrastructure is inadequate such as e.g. in developing countries (India, China, etc.). Future cryogen price increases could render such cooling rather expensive.

Mechanical cooling apparatus, so-called cryocoolers, have recently been used to a greater extent for directly cooling superconducting magnet systems. In addition to cooling without cryogenic fluids (so-called dry cooling), there are conventional systems that contain at least one further cryogenic fluid that is, however, reliquefied by the cryocooler after evaporation. For this reason, none or nearly none of the cryogenic fluid escapes to the outside. The documents EP 0 905 436, EP 0 905 524, WO 03/036207, WO 03/036190, U.S. Pat. No. 5,966,944, U.S. Pat. No. 5,563,566, U.S. Pat. No. 5,613,367, U.S. Pat. No. 5,782,095, U.S. Pat. No. 5,918,470, US 2002/0002830 and US 2003/230089 describe such possible cooling of a superconducting magnet system using a cryocooler without losing cryogen.

The e.g. two-stage cold head of the cryocooler may be installed in a separate vacuum space (as described e.g. in U.S. Pat, No. 5,613,367) or directly in the vacuum space of the cryostat (as described e.g. in U.S. Pat. No. 5,563,566) in such a manner that the first cold stage of the cold head is attached to a radiation shield and the second cold stage is connected in a heat-conducting fashion to the cryocontainer either directly or indirectly via a fixed thermal bridge. The overall heat input into the cryocontainer can be compensated for through re-condensation of the helium, which evaporates due to heat input from the outside, on the cold contact surface in the cryocontainer, permitting loss-free operation of the system. Disadvantageously, the connection between the second cold stage and the cryocontainer has a thermal resistance, and vibrations of the cryocooler may be transmitted to the cryocontainer and the magnet even if “soft” heat transferring elements (e.g. braided wires) are used. In high-resolution NMR systems even small disturbances can be problematic and prevent meaningful measurements.

One way to avoid these disadvantages is to insert the cold head into a neck tube which connects the outer vacuum sleeve of the cryostat to the cryocontainer and is correspondingly filled with helium gas, i.e. a cryogenic fluid in the gaseous phase, as described e.g. in the document US 2002/0002830. The first cold stage of the two-stage cold head is in fixed conducting contact with a radiation shield. The second cold stage is freely suspended in the helium atmosphere and directly liquefies the evaporated helium. Since the cooling performance of the cryocooler is larger than the thermal input into the cryocontainer, an additional heating means evaporates a sufficient amount of helium to obtain a stationary state. The controlled variable for the heating means may e.g. be the pressure in the cryocontainer.

A system of this type has, however, the disadvantage that the neck tube opens at the bottom into the helium container. To service the cryocooler, either the neck tube bottom must be closed via a special device to prevent the technician from getting injured in case of a magnet quench, or the magnet must be discharged, which causes an undesired downtime for the magnet system. Moreover, the asymmetric opening also exerts asymmetric forces on the helium container during normal operation, which must be compensated for by special centering elements. In case of a quench, the forces acting on the suspension tubes increase and the cryocooler is also subjected to the full quench pressure. For this reason, the cold head must be connected to the outer shell in a relatively rigid manner, which has an unfavorable effect on dampening of vibrations between the cold head and the outer shell. The neck tube may also have a comparably large wall thickness leading to large neck tube heat input. Since the neck tube and neck tube installations are subjected to the increased quench pressure in case the magnet quenches, these cryostat components are often also subject to more stringent guidelines imposed by the authorities, which, in turn, involves additional effort (e.g. proof of traceability of the components) and increased cost.

It is therefore the underlying purpose of the present invention to propose a cryostat configuration with integrated cryocooler which is of simple construction, wherein the heat transfer between the cooler cold head and the cryostat configuration is efficient and with little vibration, and which offers great safety during operation, in particular, also for maintenance work.

### SUMMARY OF THE INVENTION

This object is achieved in accordance with the invention in that the neck tube is disposed between the outer shell of the cryostat configuration and at least one cryocontainer and/or the radiation shield, the neck tube being closed in a gas-tight manner at the end facing the cryocontainer and/or the radiation shield and coupled to one of the cryocontainers and/or a radiation shield which is disposed between the cryocontainers or between a cryocontainer and the outer shell, via a connection having a good thermal conductivity, wherein the neck tube has a fill-in device at its ambient temperature end for filling a cryogenic fluid into the neck tube.

The comparably simple construction requires no or hardly any additional expense compared to a cryostat configuration without cryocooler, especially to adopt the additional mechanical loads in case of a magnet quench, and to meet the high safety requirements and demands imposed by the authorities.

The neck tube housing the cold head of the cryocooler used for cooling is separated in a gas-tight manner from the cryocontainer, such that the neck tube is in its own cryogen atmosphere. The cryogenic region around the cryocooler is therefore completely separated from the cryocontainer. The heat is transferred from the cold head to the cryocontainer indirectly via the cryogen located in the neck tube (through evaporation and condensation of part of the liquid cryogen located in the neck tube) without any contact between the cryocooler cold head and the cryocontainer. No vibrations are therefore transmitted from the cold head to the cryocontainer and the magnet configuration.

Since the inventive cryostat configuration has no direct opening between the end of the neck tube and the cryocontainer, e.g. the helium container, the forces released by a magnet quench do not act on the cryocooler. This permits safe installation and removal of the cold head without interrupting operation of the system contained in the cryostat configuration. In this case, the cryocontainer has no opening to the outside except for the suspension tubes. In case of a quench, the forces acting on the cold head are no larger than during normal operation except for a purely static force due to the inner pressure which is slightly higher compared to the ambient pressure. For this reason, the connection between the cold head and the outer shell may be less rigid than for a neck tube which opens towards the cryocontainer. The inventive cryostat configuration therefore permits vibration-damped, softer support on the outer shell and/or the use of a neck tube with thinner walls to reduce the heat input into the cryocontainer. Moreover, the neck tube and further neck tube installations must no longer meet the strict guidelines and safety regulations for pressure containers imposed by the authorities, which reduces production costs.

The neck tube preferably contains the same cryogenic liquid as the cryocontainer. This is relevant, in particular, if the neck tube is thermally conductingly connected to the cryocontainer and not exclusively to the radiation shield. The cryogenic atmosphere in the neck tube may be supplied by the cryogen supply in the cryocontainer, as is described below.

Alternatively, the neck tube and the cryocontainer may contain different cryogenic fluids. This is possible by connecting the neck tube exclusively to the radiation shield in a heat-conducting manner or if the cryogenic fluid in the neck tube has a lower boiling point than the cryogenic fluid in the cryocontainer at the same pressure.

The neck tube is advantageously produced from a material having a poor thermal conductivity, comparable to those of stainless steel. The heat input into the cryocontainer can thereby be reduced. The neck tube wall may be thinner than that of a neck tube which is open towards the cryocontainer due to the smaller load in case of a quench, which also reduces the heat input.

In a particular embodiment of the invention, at least sections of the neck tube are formed as bellows. The neck tube can therefore adapt to expansion or contraction of the cryocontainer. The amount of heat guided from the warm end to the cold end of the neck tube is less than with a straight tube.

In a preferred embodiment of the inventive cryostat configuration, the closed end of the neck tube directly contacts the cryocontainer or the radiation shield. The heat is transferred from the cryocontainer or radiation shield to the cryogen in the neck tube only via a wall separating the neck tube from the cryocontainer or radiation shield.

The thermal resistance between the neck tube and the cryocontainer or the radiation shield is thereby smaller than 0.05 K/W, preferably smaller than 0.01 K/W. To meet this demand, the surface area of the separating wall must be correspondingly large or the thickness of the separating wall must be correspondingly small and the material of the separating wall must have a good thermal conductivity.

Alternatively, the closed end of the neck tube may not directly contact the cryocontainer or the radiation shield but be connected thereto via rigid or flexible elements having a good thermal conductivity. This may be realized e.g. by copper wires braided into strands. In this case, the thermal resistance between the neck tube and the cryocontainer is larger than in case of a direct connection via a separating wall, but transmission of vibrations between the neck tube and the cryocontainer is reduced. Moreover, no additional asymmetric load acts on the cryocontainer even during normal operation, as is the case with direct contact between the neck tube and the cryocontainer. Centering elements in the form of tension or pressure centerings, which position the cryocontainer in its central position, are evenly loaded and may be designed like in cryostat configurations without an additional neck tube.

The thermal resistance between the neck tube and the cryocontainer or radiation shield is thereby less than 0.1 K/W, preferably less than 0.05 K/W. The number, length, diameter and material of the strands must be selected accordingly.

In an advantageous embodiment of the inventive cryostat configuration, the neck tube is connected to an external cryogenic fluid reservoir via the fill-in device. In this manner, cryogenic fluid can be constantly supplied to the neck tube during cooling of the cryostat configuration. The cryogenic fluid may also be a (high-pressure) gas at room temperature and be permanently connected to the neck tube via a pressure-reducing valve, i.e. also after cooling, such that even in case of a leakage in the neck tube region and the resulting gas leakage towards the outside, gas can always be supplied from the external reservoir.

In one particularly preferred embodiment, the cryocontainer is suspended at at least one suspension tube which is connected to the outer shell of the cryostat configuration, wherein the outer shell, the cryocontainer(s), the neck tube and the at least one suspension tube define an evacuated space, and wherein the neck tube is connected to at least one suspension tube of the cryocontainer via a connecting line which can be shut off and which comprises a rapid-action valve. During the cooling phase of the cryostat configuration, cryogen can be guided from the cryocontainer into the neck tube via the suspension tube and the connecting line which can be shut off. The cryogen escaping from the suspension tube in the form of gas at ambient temperature is thereby re-cooled on the neck tube wall and/or the tubes of the cold head of the cooler and even liquefied in the final cooling phase at the lower end of the neck tube or cold head. The rapid-action valve prevents a pressure increase in the region of the neck tube in case of a quench of the magnet configuration, when the shut-off valve is open and the pressure in the cryocontainer increases. As soon as a larger amount of (quench) gas flows through the connecting line, the rapid-action valve closes automatically to decouple the neck tube from the cryocontainer. The pressure in the region of the neck tube remains approximately the same. For this reason, the neck tube and further neck tube installations are no longer subject to the strict guidelines and safety regulations for pressure containers imposed by the authorities, and the production costs decrease. Installation work on the cooler and neck tube can be performed while the magnet is charged without endangering the technician in case of a quench.

Moreover, at least one suspension tube of the cryocontainer, which is connected to the neck tube in a heat-conducting manner, may additionally be connected to an additional line or exclusively to the additional line which is in thermal contact with the neck tube and terminates in the cryocontainer, wherein a shut-off device and/or a pump may be inserted in the additional line. The additional line does not connect the cryocontainer to the inside of the neck tube but is guided past it, forming a gas flow through the suspension tube and the additional line and back into the cryocontainer. The ascending gas thereby accepts heat from the wall of the suspension tube, cooling it, and being cooled again in the additional line in that region where it is connected to the neck tube. This reduces the heat input into the cryocontainer via the suspension tube(s).

In an alternative embodiment of the inventive cryostat configuration, the cryocontainer is connected to the end of the neck tube, which is at ambient temperature, via at least one fluid line which is guided through the outer shell of the cryostat configuration, wherein the outer shell, the at least one cryocontainer, the neck tube and the at least one fluid line define an evacuated space, and wherein a rapid-action valve and a shut-off device are integrated in the fluid line in the region between the outer shell and the neck tube. This fluid line can guide cryogen from the cryocontainer into the neck tube even in cryostat configurations which are not suspended from suspension tubes.

In a preferred embodiment, the cryocooler is a pulse tube cooler or a Gifford-McMahon cryocooler having at least two cold stages. Two cold stages generate particularly low temperatures and can provide two different temperature levels.

A temperature of 77 K or less can be generated at one cold stage of the cold head of the cryocooler and at the same time liquid helium of a temperature of 4.2 K or less at another (second) cold stage.

At least one cold stage of the cryocooler cold head, which is not the coldest cold stage, is advantageously thermally coupled to a radiation shield or an additional cryocontainer which is not the coldest cryocontainer. In this manner, the heat input into the radiation shield is adsorbed or the cryogen loss in the additional cryocontainer is compensated for or at least reduced.

This thermal coupling between the at least one cold stage and the radiation shield or the additional cryocontainer is preferably a flexible and/or rigid solid connection which penetrates the neck tube wall. The connection between the cold stage and the neck tube wall may e.g. be rigid and the connection between the neck tube wall and the radiation shield or additional cryocontainer may be flexible in the form of copper strands.

In a particularly advantageous manner, a gas gap is provided between the at least one cold stage of the cold head of the cryocooler and the solid connection connected to the neck tube wall for thermal coupling of the at least one cold stage to the radiation shield or the additional cryocontainer. In this manner, the transmission of vibrations from the cold head to the radiation shield or the additional cryocontainer can be minimized, wherein the heat transmission is still sufficient. The solid connection may moreover be flexible or rigid.

The cryocooler of the inventive cryostat configuration may, however, also be a pulse tube cooler or a Gifford-McMahon cryocooler having one cold stage.

The cold stage can preferably produce a temperature of 77 K or less, e.g. for liquefying nitrogen, permitting cooling of a cryocontainer with liquid nitrogen or of a radiation shield.

In order to prevent unnecessary heat input from the neck tube into the tubes of the cold head of the cryocooler, the tubes of the cold head of the cryocooler are advantageously at least partially surrounded by a thermal insulation in the region of at least one cold stage.

In one preferred embodiment of the invention, at least one of the cryocontainers comprises an electric heating means to control the pressure in the cryocontainer.

This control is also possible when an electric heating means is provided in or on the neck tube.

An electric heating means may also be provided at at least one cold stage of the cryocooler, which is in contact with this cold stage. The pressure in the cryocontainer can also be indirectly kept constant via this heating means.

The invention can be utilized with particular advantage if the superconducting magnet configuration is part of an apparatus for magnetic resonance spectroscopy, in particular, magnetic resonance imaging (MRI) or nuclear magnetic resonance spectroscopy (NMR). The elimination of disturbances due to vibrations is particularly important for recording MRI or NMR data. Direct cooling by the cryocooler ensures long, continuous operation. Even maintenance and repair works on the cooler can be performed with great safety for the personnel, without discharging the magnet and causing long downtimes. The additional expense for apparatus and construction is within tolerable limits.

Further advantages of the invention can be extracted from the description and the drawings. The features mentioned above and below may be used individually or collectively in arbitrary combination. The embodiments shown and described are not to be understood as exhaustive enumeration but have exemplary character for describing the invention.

### BRIEF DESCRIPTION OF THE DRAWING

FIG. 1 shows a schematic view of a cryostat configuration with a neck tube which is open towards a cryocontainer, and a cold head, integrated therein, of a cryocooler in accordance with prior art;

FIG. 2 shows a schematic view of an inventive cryostat configuration with direct contact between a closed neck tube and the cryocontainer and with closed connecting line between a suspension tube of the cryocontainer and the neck tube;

FIG. 3 shows a schematic view of a further embodiment of an inventive cryostat configuration with indirect contact between the neck tube and the cryocontainer and with closed connecting line between the suspension tube of the cryocontainer and the neck tube;

FIG. 4 shows a schematic view of an inventive cryostat configuration with open connecting line between the suspension tube of the cryocontainer and the neck tube;

FIG. 5 shows a schematic view of the region of the neck tube and the temperature gradient in the lower region of the cryogen bath of the neck tube of an inventive cryostat configuration with open connecting line between the suspension tube of the cryocontainer and the neck tube;

FIG. 6 shows a schematic view of an inventive cryostat configuration with a connecting line between the suspension tube of the cryocontainer and the cryocontainer, wherein the connecting line is in thermal contact with the neck tube;

FIG. 7 shows a schematic view of an inventive cryostat configuration during cooling of the cryocontainer and the neck tube, wherein the neck tube is connected to an external gas reservoir of a cryogenic fluid; and

FIG. 8 shows a schematic view of a further embodiment of an inventive cryostat configuration for cooling a radiation shield.

### DESCRIPTION OF THE PREFERRED EMBODIMENT

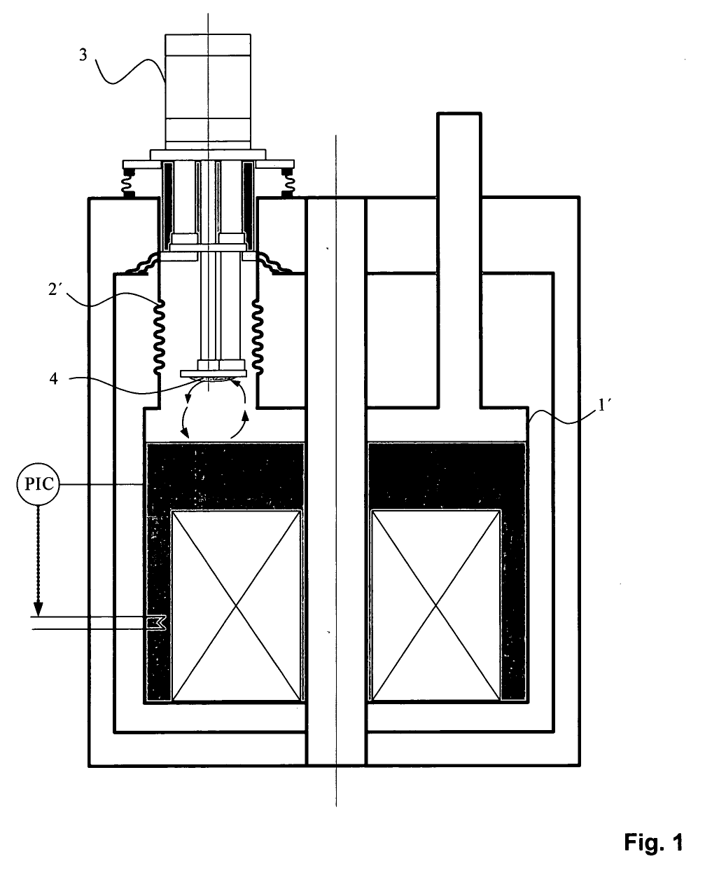

FIG. 1 shows a cryostat configuration comprising a superconducting magnet coil 26 with a neck tube 2′ which is open towards a cryocontainer 1′, is partially formed as a bellows, and contains a two-stage cold head 3 of a cryocooler. The cryogen 4 which is liquefied at the cold head 3 drips directly into the cryocontainer 1′ from which the cryogen that evaporates due to heat input into the cryocontainer 1′ rises into the neck tube 2′ to be reliquefied by the cold head 3. In case the magnet quenches, the pressure in the cryocontainer 1′ and also in the neck tube 2′ rapidly increases, such that safe installation or removal of the cold head 3 during operation of the cryostat configuration cannot be ensured. Since the neck tube 2′ is also subjected to the increased pressure in case of a quench, it must be designed to bear the high mechanical loads during a quench. Moreover, the neck tube 2′ and further neck tube installations must meet stricter guidelines and safety regulations imposed by the authorities.

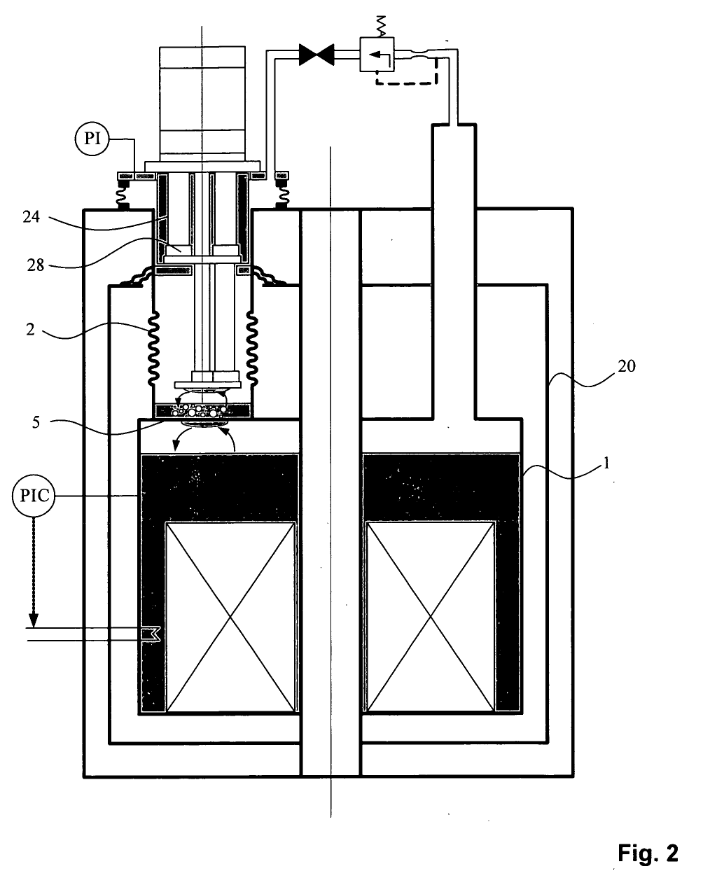

FIG. 2 shows one embodiment of the inventive cryostat configuration with a superconducting magnet coil 26, wherein the cryocontainer 1 is separated from a neck tube 2 in a gas-tight manner. The neck tube 2 is, however, in direct thermal contact with the cryocontainer 1 via a separating wall 5.

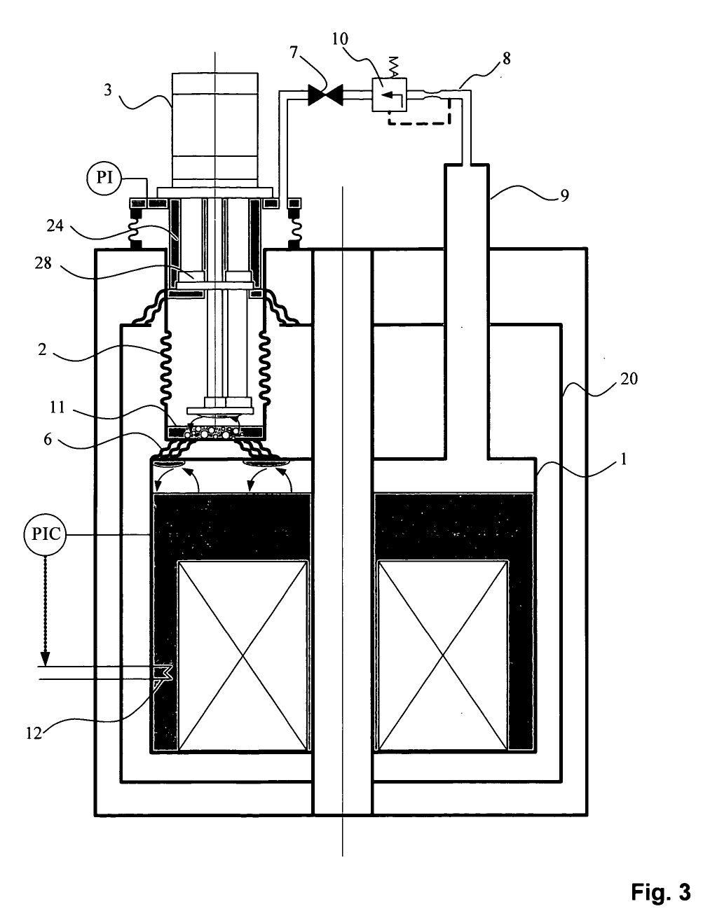

FIG. 3 shows an alternative embodiment, wherein the thermal contact between the neck tube 2 and the cryocontainer 1 is realized indirectly via flexible elements 6 having a good thermal conductivity. Both embodiments comprise a connecting line 8 which can be shut-off via a shut-off valve 7 and which connects a suspension tube 9 of the cryostat configuration to the neck tube 2. A rapid-action valve 10 is integrated in the connecting line 8 to ensure that the pressure in the region of the neck tube 2 does not rise in case of a quench when the shut-off valve 7 is open. Thus, the neck tube 2 must no longer meet the stricter guidelines and safety regulations for pressure containers imposed by the authorities, which reduces production costs. Assembly works on the cold head 3 of the cooler and neck tube 2 may be performed while the magnet coil 26 is charged and the shut-off valve 7 is open without endangering the technician in case of a quench. A throttle device is normally integrated in a rapid-action valve 10 across which a pressure drop occurs in case of a sudden increase in gas flow which causes the valve to close against an (adjustable) spring.

The system is self-regulating. At the start, the shut-off valve 7 in the connecting line 8 between the cryocontainer 1 and the neck tube 2 is open, and therefore the pressure in the neck tube 2 and in the cryocontainer 1 is the same. During cooling of the cryostat configuration, cryogen is continuously supplied from the cryocontainer 1 to the neck tube 2 during and after filling the cryocontainer 1 with cryogenic liquid with the cryocooler being switched on. If the lower ends of the neck tube 2 and of the cold head 3 of the cryocooler are sufficiently cold, and if the cooling power of the cryocooler is also larger than the heat input into the cryocontainer 1 and into the neck tube 2, the cold head 3 starts to liquefy cryogen which collects in the lower region of the neck tube 2 in the form of a cryogen bath 11. In subsequent operation, the cryocooler sucks in more and more cryogen from the cryocontainer 1 via the connecting line 8 such that the liquid level of the cryogen bath 11 in the neck tube 2 continuously rises. Moreover, the pressure in the neck tube 2 and also in the cryocontainer 1 decreases, since the amount of gas liquefied by the cryocooler is larger than the amount of evaporated liquid. The pressure in the neck tube 2 and in the cryocontainer 1 is the same, and therefore the temperature in both partial areas is also the same (=the boiling temperature associated with the prevailing (vapor) pressure). Since there is no temperature difference between the cryocontainer and the neck tube, there is no heat flow between the cryocontainer 1 and the cryogen bath 11 in the neck tube 2.

The shut-off valve 7 in the connecting line is then closed (FIGS. 2 and 3). The cold head 3 continues to liquefy cryogen. No more cryogen can flow out of the cryocontainer 1, and therefore the pressure in the region of the neck tube 2 drops. The lower pressure in the region of the neck tube 2 is associated with a lower boiling temperature of the cryogen bath 11 with the result that a temperature difference is generated between the cryocontainer and the neck tube resulting in a heat flow from the cryocontainer 1 into the cryogen bath 11 of the neck tube 2. Evaporated cryogen is condensed in the cryocontainer 1 on the slightly colder separating wall 5 (FIG. 2) or on the wall of the cryocontainer (FIG. 3) and gives off condensation heat which flows through the separating wall 5 (FIG. 2) or via the heat-conducting elements 6 (FIG. 3) and causes evaporation of cryogen in the cryogen bath 11 of the neck tube 2. The cryogen vapor then rises in the neck tube 2, is liquefied at the second cold stage 27 of the cold head 3 and drips back into the cryogen bath 11 of the neck tube 2. Thus, there are two separate cryogen circuits (evaporation and condensation) which are coupled to each other, wherein the heat is transmitted over a similar distance as in a conventional cryostat configuration, but via a separating wall 5 or elements 6 with a good thermal conductivity, from one closed system to another closed system with only a slight temperature difference, similar to two interconnected heat pipes.

If the cooling power of the cryocooler is higher than is required for condensing the evaporated cryogen, further gas from the neck tube 2 is liquefied and the pressure therein drops. This again causes a temperature drop in the cryogen bath 11 in the neck tube 2 with the result that the heat flow through the separating wall 5 or elements 6 having a good thermal conductivity increases and more cryogen evaporates from the cryogen bath 11 of the neck tube 2. Conversely, more vapor is condensed in the cryocontainer 1, such that the pressure therein also decreases unless external measures are taken. The pressure in the cryocontainer 1 is preferably controlled to a value which is larger than the ambient pressure, which can be realized via a controller PIC which controls a heating means 12 in the cryocontainer 1 in such a manner that the excess power of the cryocooler 1 is compensated for and the pressure remains constant. An equilibrium is quickly established, wherein the amount of cryogen evaporating in the cryogen bath 11 in the neck tube 2 is the same as the amount that can be reliquefied by the cryocooler 1.

The temperature difference and therefore also the pressure difference between the cryocontainer 1 and the neck tube 2 depend on the efficiency of heat transfer, the size of the heat transfer surface, as well as the thickness and the material of the separating wall 5. The better the heat transfer, the larger the heat transfer surface, the thinner the separating wall 5 and the higher the thermal conductivity of the wall 5, the smaller are the temperature and pressure differences.

The thermal resistance of the flexible elements 6 having a good thermal conductivity of FIG. 3 is normally larger than that of the separating wall 5 of FIG. 2. To prevent an excessive increase in the temperature and pressure differences between the cryocontainer 1 and the neck tube 2, the thermal resistance of the elements 6 should not be more than 0.1 K/W. If the cooler adsorbs a heat flow of 0.5 W at the second cold stage 27, a temperature difference of 0.05 K is generated between the cryocontainer 1 and the neck tube 2 which corresponds to a pressure difference of approximately 48 mbar. If the pressure in the cryocontainer 1 is controlled to 1.04 bar, the pressure in the neck tube is 0.992 bar which is higher than ambient pressure at a height of approximately 500 m above sea level in most weather conditions. It must also be noted that when the temperature at the second cold stage 27 decreases, the (cooling) capacity of the cryocooler also decreases. This is another reason why a small thermal resistance is desired for the separating wall 5.

The configuration of FIG. 3 is advantageous in that, even during normal operation, no additional asymmetric load on the cryocontainer 1 is generated. For this reason, the centering elements which center the cryocontainer 1 relative to the outer shell, may be designed as in a conventional cryostat configuration (without direct cooling with a cryocooler).

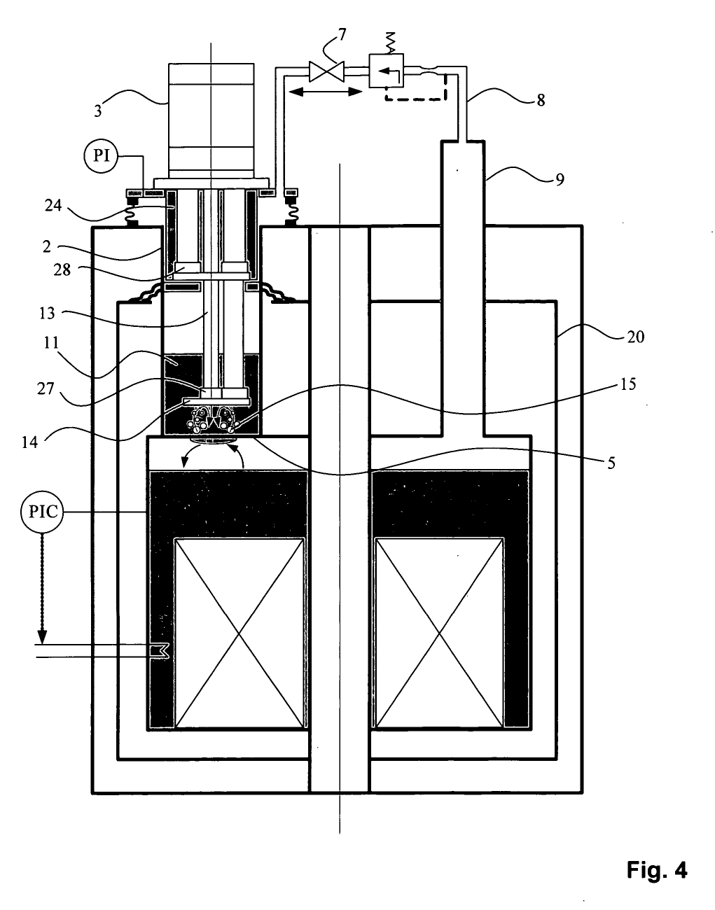

The proposed configuration functions even when the connecting line 8 between the suspension tube 9 and the neck tube 2 remains open, as is shown in FIG. 4. If the shut-off valve 7 in the connecting line 8 is not closed after cooling, more and more liquid cryogen collects in the cryogen bath 11 in the neck tube 2. The liquid level of the cryogen bath 11 finally reaches the second cold stage 27 of the cold head 3 and rises around the pulse and regenerator tube 13 of the second cold stage 27 of the cold head 3. The cryogen vapor in the neck tube 2 no longer condenses on the second cold stage 27 but on the liquid surface of the cryogen bath 11.

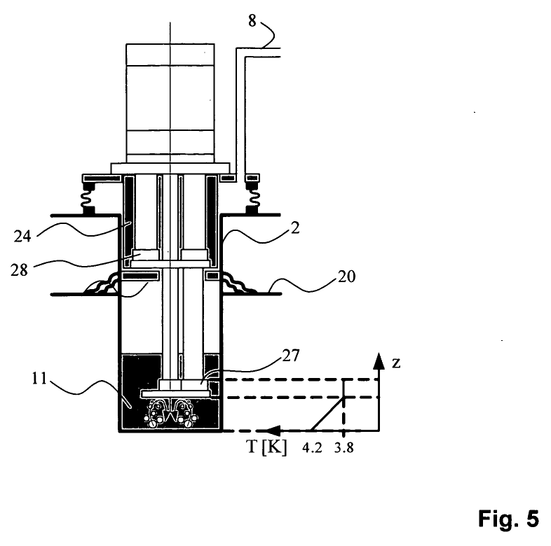

If the second cold stage 27 of the cold head 3 has excess power, its temperature will drop below the boiling temperature of the cryogen associated with this pressure, and the liquid in the cryogen bath 11 close to the flange 14 of the second cold stage 27 will sub-cool. FIG. 5 shows the temperature gradient in the lower region of the cryogen bath 11 of the neck tube 2 of an inventive cryostat configuration with open connecting line 8. The sub-cooling of the cryogen close to the flange 14 of the second cold stage 27 causes the liquid to sink at that location due to its higher density. Liquid evaporates in the neck tube 2 on the separating wall 5 between the neck tube 2 and the cryocontainer 1, having a temperature slightly below the equilibrium temperature associated with the (vapor) pressure in the neck tube 2 or cryocontainer 1, producing vapor bubbles 15. The vapor bubbles 15 rise and reach the region of the colder liquid and the vicinity of the flange 14 of the second cold stage 27, where they collapse giving off condensation heat. A partially two-phase convection flow forms between the separating wall 5 and the flange 14 of the second cold stage 27 of the cryocooler.

Additional heat is transferred through thermal conduction between the separating wall 5 and the second cold stage 27. Since liquid cryogen, such as e.g. liquid helium, has relatively poor heat conducting properties, the heat flow can generally be neglected considering the small temperature difference and the usually available exchange surfaces and distances between the separating wall 5 and the second cold stage 27.

It must be noted that the cooling power is lower due to the lower temperature of the second cold stage 27 of the cryocooler. Moreover, it can also decrease due to the changed ambient conditions (liquid instead of gas) around the tubes 13 of the second cold stage 27 of the cryocooler compared to a configuration with closed connecting line 8. As soon as the heat input into the cryogen bath 11 of the neck tube 2 via the separating wall 5 and the other contributions to the heat input (e.g. via the wall of the neck tube 2) have reached the magnitude of the cooling power of the cryocooler at the lower temperature, an equilibrium state is reached.

Operation of the inventive cryostat configuration with open connecting line 8 (FIGS. 4 and 5) has the disadvantage that the cooling power of the second cold stage 27 of the cryocooler, provided at the boiling temperature of the cryogen, cannot be utilized since the temperature of the second cooling stage 27 and therefore also the cooling power of the cryocooler in the sub-cooled liquid are lower. A great advantage of this configuration is that even in case of cryogen leakage to the outside in the region of the neck tube 2, cryogen is constantly supplied from the cryocontainer 1, thereby maintaining the function of the configuration for a long time or preventing an underpressure from being generated. The cryogen loss to the outside is a minor disadvantage which can be tolerated temporarily. If however, there is a leakage to the outside in the region of the neck tube 2 when the connecting line is closed (FIGS. 2 and 3), the pressure in the region of the neck tube 2 drops as well as the temperature in the liquid bath 11 of the neck tube 2. Due to the larger temperature difference across the separating wall 5, a greater amount of liquid evaporates in the neck tube 2 and more helium vapor condenses on the separating surface 5 in the cryocontainer 1.

Moreover, the entire liquid bath 11 in the neck tube 2 could evaporate and an underpressure generated in the neck tube 2.

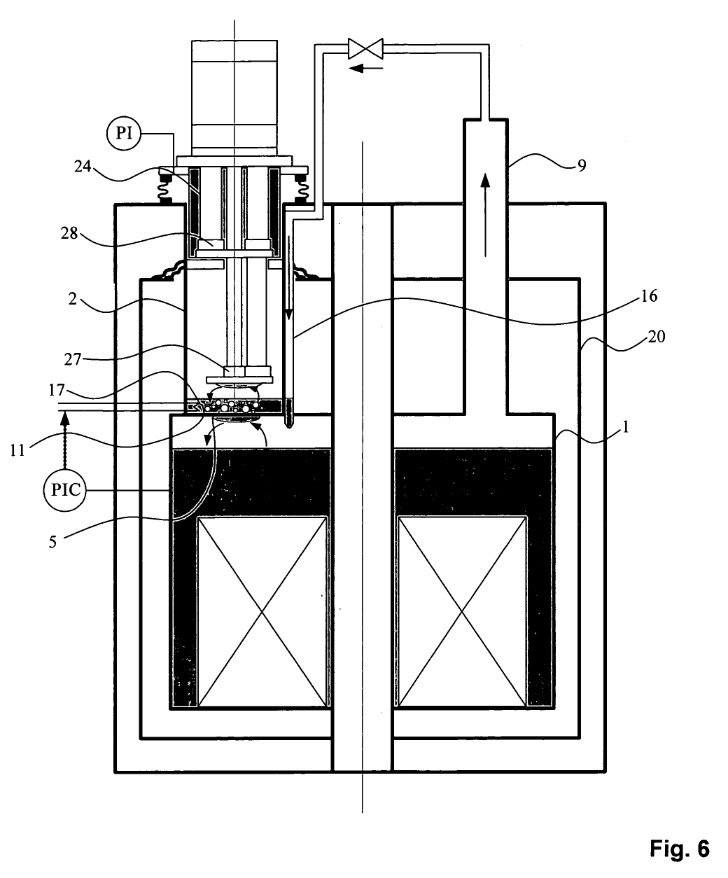

FIG. 6 shows a further embodiment of the inventive cryostat configuration having an additional line 16 which is connected to the suspension tube 9 and is being guided along the neck tube 2 into the cryocontainer 1. This additional line 16 guides cryogen from the cryocontainer 1 via the suspension tube 9 back into the cryocontainer 1. The cryogen vapor rising in the suspension tube 9 adsorbs the heat entering via the tube wall, and is heated to ambient temperature when it exits the suspension tube 9. This prevents heat input from the outside into the cryocontainer 1 via the suspension tube 9. This cooling flow is maintained by the suctioning effect at the end of the additional line 16 connected to the cold end of the neck tube 2. FIG. 6 shows a neck tube 2 which is already filled with cryogen. The neck tube 2 may be filled by a fill-in device (not shown). An additional connecting line may e.g. be provided (as shown in FIGS. 2 through 4) which supplies cryogen to the neck tube 2 via a further suspension tube (not shown in FIG. 6). The additional line 16 may also be a branched line, wherein one branch terminates in the neck tube 2 and the other branch is guided past the neck tube 2.

To control the pressure in the cryocontainer, the embodiment of FIG. 6 comprises a heating means 17 in the neck tube 2 in the cryogen bath 11. A heating means may moreover also be mounted directly to the second cold stage 27 of the cryocooler, which is controlled in such a manner that the pressure in the cryocontainer 1 remains constant. The dimensions and the material of the above-described heat-transferring separating wall 5 between the neck tube 2 and the cryocontainer 1 also influence the pressure in the neck tube. The separating wall 5 should therefore be large and thin and be made from a material having a good thermal conductivity, such that the pressure in the neck tube 2 never becomes much lower than in the cryocontainer 1, possibly even generating an underpressure relative to the surroundings. This prevents moist air from being sucked in from the outside and freezing water vapor in case of leakage.

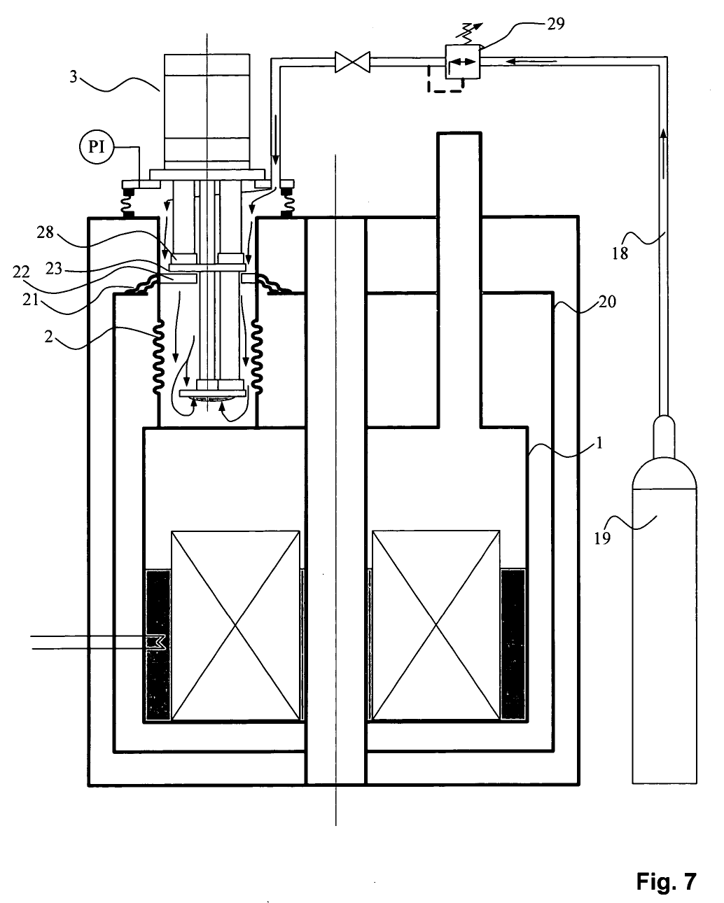

FIG. 7 shows an inventive cryostat configuration during cooling of the cryocontainer 1 and the neck tube 2. Cryogenic fluid can be guided from an external reservoir 19 via a feed line 18 into the neck tube 2 (arrows in FIG. 7). The cryogenic fluid from the external reservoir 19 enters the neck tube 2 in the form of gas and is cooled along the tubes of the cold head 3 or the neck tube 2 wall. The cryogen is finally liquefied at the second cold stage 27 of the cold head 3 and drips onto the separating wall 5 between the neck tube 2 and the cryocontainer 1. A pressure-reducing valve 29 is integrated between the external reservoir 19 and the neck tube 2. It is adjusted to a pressure which is slightly above ambient pressure. If the pressure in the neck tube 2 is lower or equal to the adjusted pressure, further gas enters. If a steady operating state has been established after cooling (including control of the pressure in the cryocontainer 1 and neck tube 2 using the heating means 12 in the cryocontainer 1 or heating means 17 in the neck tube 2), the gas flow from the external reservoir 19 is stopped. In case of leakage in the neck tube 1, no underpressure is generated in the neck tube. A drop of the (gas) pressure in the external reservoir 19 below a limit value could e.g. trigger an alarm in the monitoring system of the cryostat configuration.

In all embodiments, the heat transfer between the second cold stage 27 of the cryocooler and the cryocontainer 1 is completely contact-free. Transfer of vibrations is therefore largely prevented.

When using a two-stage cryocooler (FIGS. 2 through 7), a radiation shield 20 or a further cryocontainer (e.g. with liquid nitrogen) is normally in contact with the first cold stage of the cold head 3 and thereby directly cooled. The first cold stage may thereby be rigidly connected to the radiation shield 20 or (preferably) via flexible connecting elements 21 having a good thermal conductivity, such as e.g. copper strands. To suppress transmission of vibrations between the first cold stage and the radiation shield 20 even more effectively, a small gas gap 23 may be left e.g. between the first cold stage and a contact flange 22 which is then connected to the radiation shield 20 either directly or again via flexible connecting elements 21 having a good thermal conductivity (see e.g. FIG. 2 and FIGS. 4 through 7). If the cooling capacity at the first cold stage is sufficient, this additional thermal resistance can be neglected and the temperature of the radiation shield 20 does not increase excessively.

To prevent or at least reduce undesired heat input from the neck tube 2 into the tubes 13 of the cold head, the tubes 13 of the cold head are surrounded by thermal insulation 24 in the region of the first cold stage and possibly also in the region of further cold stages. The tubes above the first cold stage of the cold head have temperatures between room temperature and the temperature of the first cold stage.

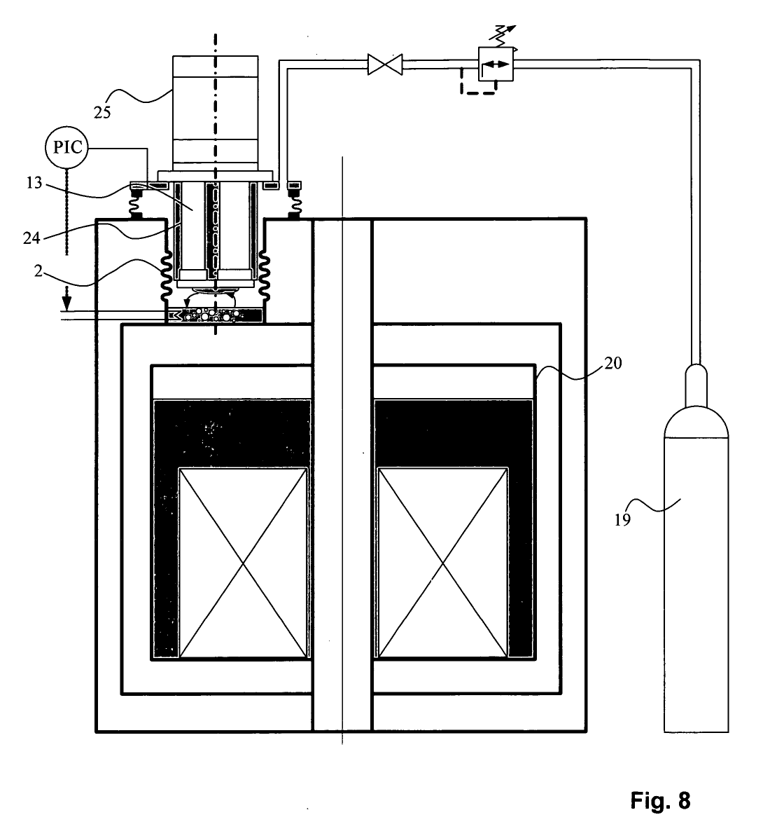

In general, the cryocontainer 1 cannot be cooled by a one-stage cold head 25 due to the excesssively low temperature, e.g. when it contains liquid helium. It is, however, feasible to cool either a further cryocontainer (in most cases a container with liquid nitrogen) or a radiation shield 20 in an analog manner as described above. FIG. 8 shows an embodiment of this type. The neck tube 2 is filled with a suitable cryogen (e.g. nitrogen, argon, neon) from an external reservoir 19. It may again be advantageous to thermally insulate 24 the tubes 13 of the cryocooler in the region between room temperature and the temperature of the cold stage. Also in this case, the neck tube 2 need not be directly connected to the radiation shield 20 or the further cryocontainer. Flexible elements 6 having a good thermal conductivity can also be used in this case to prevent the occurrence of asymmetric forces and aggravate transmission of vibrations (see also FIG. 3).

### List of Reference Numerals

1′ cryocontainer (prior art)
2′ neck tube (prior art)
1 cryocontainer
2 neck tube
3 cold head
4 liquefied cryogen
5 separating wall
6 elements having a good thermal conductivity
7 shut-off valve
8 connecting line
9 suspension tube
10 rapid-action valve
11 cryogen bath
12 heating means in the cryocontainer
13 tubes of the cold head
14 flange of the second cold stage
15 vapor bubbles
16 additional line
17 heating means in the neck tube
18 feed line
19 external reservoir
20 radiation shield
21 flexible connecting elements
22 contact flange
23 gas gap
24 thermal insulation
25 one-stage cold head
26 magnet coil
27 second cold stage of the cold head
28 first cold stage of the cold head
29 pressure-reducing valve

We claim:

1. A cryostat configuration for keeping at least one cryogenic fluid, the configuration comprising:
an outer cryostat shell;
at least one cryocontainer for one cryogenic fluid, said cryocontainer disposed within said outer shell;
a cryocooler having a cold head, a coldest cold stage of said cold head being disposed in a contact-free manner relative to said cryocontainer;
a radiation shield disposed between said cryocontainer and said outer shell;
a neck tube structured, disposed, and dimensioned for containing said cryocooler cold head without contacting said coldest cold stage thereof, said neck tube for containing one cryogenic fluid, wherein said neck tube is disposed between said outer shell and said cryocontainer and/or between said outer shell and said radiation shield, said neck tube being closed in a gas-tight manner at an end thereof facing said cryocontainer and/or said radiation shield, said neck tube having means for filling the crogenic fluid into said neck tube, said filling means disposed at an end of said neck tube at ambient temperature; and
means for thermally connecting said neck tube to said cryocontainer and/or to said radiation shield, said connecting means having good thermal conductivity.

2. The cryostat configuration of claim 1, wherein a superconducting magnet configuration is disposed in one of said at least one cryocontainers.

3. The cryostat configuration of claim 1, wherein said neck tube and said cryocontainer contain a same cryogenic fluid.

4. The cryostat configuration of claim 1, wherein said neck tube and said cryocontainer contain different cryogenic fluids.

5. The cryostat configuration of claim 1, wherein said neck tube consists essentially of a material having poor thermal conductivity or of stainless steel.

6. The cryostat configuration of claim 1, wherein at least sections of said neck tube are formed as a bellows.

7. The cryostat configuration of claim 1, wherein said closed end of said neck tube directly contacts said cryocontainer or said radiation shield.

8. The cryostat configuration of claim 7, wherein a thermal resistance between said neck tube and said cryocontainer or said radiation shield is smaller than 0.05 K/W or smaller than 0.01 K/W.

9. The cryostat configuration of claim 1, wherein said closed end of said neck tube does not directly contact said cryocontainer or said radiation shield, rather is connected thereto via rigid or flexible elements having good thermal conductivity.

10. The cryostat configuration of claim 9, wherein a thermal resistance between said neck tube and said cryocontainer or said radiation shield is smaller than 0.1 K/W or smaller than 0.05 K/W.

11. The cryostat configuration of claim 1, wherein said filling means connect said neck tube to an external cryogenic fluid reservoir.

12. The cryostat configuration of claim 1, further comprising at least one suspension tube from which said cryocontainer is suspended, said suspension tube being connected to said outer shell, and with a connecting line disposed between and connecting said neck tube and said at least one suspension tube, wherein said connecting line can be shut-off and comprises an integrated rapid-action valve, wherein said outer shell, said at least one cryocontainer, said at least one suspension tube, and said neck tube define an evacuated space.

13. The cryostat configuration of claim 1, further comprising at least one suspension tube and an additional line, wherein said suspension tube is connected to said neck tube in a heat-conducting manner and is also connected to said additional line or is exclusively connected to said additional line, said additional line being in thermal contact with said neck tube and terminating in said cryocontainer, said additional line structured and dimensioned for insertion of a shut-off device and/or a pump.

14. The cryostat configuration of claim 1, further comprising at least one fluid line which is guided through said outer shell as well as a rapid-action valve and a shut-off device which are both integrated in said fluid line in a region between said outer shell and said neck tube, wherein said fluid line connects said cryocontainer to said end of said neck tube which is at ambient temperature, said outer shell, said at least one cryocontainer, said neck tube and said at least one fluid line defining an evacuated space.

15. The cryostat configuration of claim 1, wherein said cryocooler is a pulse tube cooler or a Gifford-McMahon cooler having at least two cold stages.

16. The cryostat configuration of claim 15, wherein a temperature of 77 K or less can be generated at a cold stage of said cold head of said cryocooler and liquid helium of a temperature of 4.2 K or less can be simultaneously generated at another cold stage.

17. The cryostat configuration of claim 15, wherein at least one cold stage of said cryocooler cold head which, is not a coldest cold stage, is thermally coupled to a radiation shield or to a further cryocontainer which is not a coldest cryocontainer.

18. The cryostat configuration of claim 17, further comprising a flexible and/or rigid solid connection which penetrates through a wall of said neck tube to thermally couple said at least one cold stage to said radiation shield or to said further cryocontainer.

19. The cryostat configuration of claim 17, wherein a gas gap is defined between said at least one cold stage of said cryocooler cold head and a connection to said neck tube wall for thermal coupling said at least one cold stage to said radiation shield or to said further cryocontainer.

20. The cryostat configuration of claim 1, wherein said cryocooler is a pulse tube cooler or a Gifford-McMahon cooler comprising one cold stage.

21. The cryostat configuration of claim 20, wherein said cold stage generates a temperature of 77 K or less.

22. The cryostat configuration of claim 1, further comprising thermal insulation at least partially surrounding tubes of said cold head in a region of at least one cold stage.

23. The cryostat configuration of claim 1, further comprising an electric heating means disposed in at least one of said cryocontainers.

24. The cryostat configuration of claim 1, further comprising an electric heating means disposed in or on said neck tube.

25. The cryostat configuration of claim 1, further comprising an electric heating means disposed at at least one cold stage of the cryocooler and in contact therewith.

26. The cryostat configuration of claim 2, wherein said superconducting magnet configuration is part of an apparatus for magnetic resonance spectroscopy, magnetic resonance imaging (MRI), or nuclear magnetic resonance spectroscopy (NMR).
